(19) United States
(12) Patent Application Publication
(10) Pub. No.: US 2026/0093957 A1
(43) Pub. Date: Apr. 2, 2026

(54) GENERATING SEMI-STRUCTURED TABULAR DATA USING LLM-BASED VARIATIONAL AUTOENCODER

(71) Applicant: SAP SE, Walldorf (DE)

(72) Inventors: Paul Mattes, Singapore (SG); Rajesh Vellore Arumugam, Singapore (SG); Yi Quan Zhou, Singapore (SG)

(21) Appl. No.: 18/903,052

(22) Filed: Oct. 1, 2024

(51) Int. Cl. G06N 3/0455; G06F 16/22; G06N 3/094

(52) U.S. Cl. CPC G06N 3/0455; G06F 16/2282; G06N 3/094

(57) ABSTRACT

Methods, systems, and computer-readable storage media for during a fine-tuning phase, receiving a semi-structured data object including a set of columns and a set of rows, each row representing a record, at least one column recording unstructured data, pre-processing rows of the semi-structured data object to generate a set of text strings, each text string representing a respective row of the semi-structured data object, and executing an adversarial training process using the set of texts strings to fine-tune parameters of one or more large LLMs of a MTV-GAN to provide a fine-tuned encoder and a fine-tuned decoder, during a synthetic data generation phase, processing a latent vector through the fine-tuned decoder of a VAE of the MTV-GAN to generate at least a portion of the synthetic data, and, during a training phase, executing a training process to train the ML model using the synthetic data.

### BACKGROUND

In many data science and machine learning (ML) use cases, there is a need for large, high-quality datasets. For example, such datasets can be used as training data to train ML models for use in a variety of problem spaces. An example problem space includes autonomous systems that are tasked with matching items of one entity to items of another entity. Examples include, without limitation, matching questions to answers, people to products, bank statements to invoices, bank statements to customer accounts, and identifying redundant data between databases.

In some instances, the datasets used as training data can include heterogeneous, semi-structured data. Here, heterogeneous refers to mixed data types (e.g., numerical, categorical, textual). Example structured data can include tabular data that is recorded in columns and rows of a table. For example, each column represents a field and a respective data type and each row represents a respective record recorded in the table. Example semi-structured data can include introduction of unstructured data within structured data. For example, a column of a table can store text data, which is unstructured. Here, while the table itself is generally considered structured, content stored within the data can be unstructured.

However, obtaining real-world datasets of sufficient size and realism can be extremely challenging or even infeasible due to data privacy, security, and acquisition constraints. In view of this, synthetic datasets can be considered and can include synthetic data that, while not real-world data, accurately represents characteristics of real-world data, such that it can be largely indistinguishable from real-world data. As such, synthetic datasets can be used to, for example, train ML models that meet performance requirements (e.g., accuracy, precision, recall) when processing real-world data.

### SUMMARY

Implementations of the present disclosure are directed to provisioning synthetic, semi-structured tabular datasets that can be used, for example, to train machine learning (ML) models. More particularly, implementations of the present disclosure are directed to a variational autoencoder (VAE) that includes a set of large language models (LLMs) to generate high-fidelity, synthetic, and heterogeneous semi-structured tabular datasets from limited real-world data samples. As described in further detail herein, synthetic datasets generated in accordance with implementations of the present disclosure can be used in various use cases including, for example, training of ML models.

In some implementations, actions include, during a fine-tuning phase, receiving a first semi-structured data object including a set of columns and a set of rows, each row representing a record, at least one column recording unstructured data, pre-processing rows of the first semi-structured data object to generate a first set of text strings, each text string representing a respective row of the first semi-structured data object, and executing an adversarial training process using the first set of texts strings to fine-tune parameters of one or more large LLMs of a multi-modal tabular data VAE generative adversarial network (GAN) (MTV-GAN) to provide a fine-tuned encoder and a fine-tuned decoder, during a synthetic data generation phase, processing a latent vector through the fine-tuned decoder of a VAE of the MTV-GAN to generate at least a portion of the synthetic data, and, during a training phase, executing a training process to train the ML model using the synthetic data. Other implementations of this aspect include corresponding systems, apparatus, and computer programs, configured to perform the actions of the methods, encoded on computer storage devices.

These and other implementations can each optionally include one or more of the following features: the fine-tuned decoder decodes the latent vector to generate the at least a portion of the synthetic data; the fine-tuned encoder encodes a text string to provide the latent vector; actions further include receiving a second semi-structured data object, pre-processing rows of the second semi-structured data object to generate a second set of text strings, each text string representing a respective row of the second semi-structured data object, and generating the latent vector using a text string of the second set of text string; the at least a portion of the synthetic data is generated by populating a partial text string with missing values that are generated by the fine-tuned decoder; each of the LLMs is trained prior to execution of the adversarial training process; and data recorded in the first semi-structured data object comprises multi-modal data.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts portions of example electronic documents.

FIG. 3A depicts an example conceptual architecture in accordance with implementations of the present disclosure.

FIG. 3B depicts an example conceptual architecture in accordance with implementations of the present disclosure.

FIG. 4A depicts a portion of an example data table that records real-world, semi-structured data.

FIG. 4B depicts example text strings generated based on records of the example data table of FIG. 4A.

FIG. 4C depicts example synthetic text strings generated in accordance with implementations of the present disclosure.

FIG. 5 depicts an example process that can be executed in accordance with implementations of the present disclosure.

FIG. 6 is a schematic illustration of example computer systems that can be used to execute implementations of the present disclosure.

Like reference symbols in the various drawings indicate like elements.

### DETAILED DESCRIPTION

Implementations of the present disclosure are directed to provisioning synthetic, semi-structured tabular datasets that can be used, for example, to train machine learning (ML) models. More particularly, implementations of the present disclosure are directed to a variational autoencoder (VAE) that includes a set of large language models (LLMs) to generate high-fidelity, synthetic, and heterogeneous semi-structured tabular datasets from limited real-world data samples. As described in further detail herein, synthetic datasets generated in accordance with implementations of the present disclosure can be used in various use cases including, for example, training of ML models.

Implementations can include actions of during a fine-tuning phase, receiving a semi-structured data object including a set of columns and a set of rows, each row representing a record, at least one column recording unstructured data, pre-processing rows of the semi-structured data object to generate a set of text strings, each text string representing a respective row of the semi-structured data object, and executing an adversarial training process using the set of texts strings to fine-tune parameters of one or more large LLMs of a multi-modal tabular data VAE generative adversarial network (GAN) (MTV-GAN) to provide a fine-tuned encoder and a fine-tuned decoder, during a synthetic data generation phase, processing a latent vector through the fine-tuned decoder of a VAE of the MTV-GAN to generate at least a portion of the synthetic data, and, during a training phase, executing a training process to train the ML model using the synthetic data.

Implementations of the present disclosure are described in further detail with reference to an example problem space that includes matching entities represented in computer-readable files. For example, the problem space can include determining matches between records of a bank statement table and records of an invoice table, each of which is stored in a respective computer-readable file. In this non-limiting example, each row of the bank statement table is an entity (record) that represents a deposit to a bank account, and each row of the invoice table is an entity (record) that represents an invoice. In this non-limiting example, an autonomous system leverages one or more ML models to match a record of the bank statement table to one or more records of the invoice table. In this manner, the autonomous system can reconcile invoices to payments to clear invoices.

It is appreciated that implementations of the present disclosure are described in further detail herein with reference to the example problem space for purposes of illustration. It is contemplated, however, that implementations of the present disclosure can be realized in any appropriate problem space (e.g., matching questions to answers, people to products, bank statements to customer accounts, matching redundant data between databases).

To provide further context for implementations of the present disclosure, and as introduced above, in many data science and ML use cases, there is a need for large, high-quality datasets. For example, such datasets can be used as training data to train ML models for use in a variety of problem spaces, such as the example problem space introduced above. Numerous ML problems deal with learning patterns and insights from training data. Typically, the goal of a ML model is to enable autonomous systems to execute tasks and improve efficiencies of processes. For example, and in the example problem space, autonomous systems can implement a ML model to match payments recorded in a bank statement to invoices and automatically execute reconciliation.

In some instances, the datasets used as training data can include heterogeneous, semi-structured data. Here, heterogeneous refers to mixed data types (e.g., numerical, categorical, textual). Example structured data can include tabular data that is recorded in columns and rows of a table. For example, each column represents a field and a respective data type and each row represents a respective record recorded in the table. Example semi-structured data can include introduction of unstructured data within structured data. For example, a column of a table can store text data, which is unstructured (e.g., free-form text). Here, while the table itself is generally considered structured, content stored within the data can be unstructured.

However, obtaining real-world datasets of sufficient size and realism (i.e., accurately representing real-world scenarios) can be extremely challenging or even infeasible due to data privacy, security, and acquisition constraints. In view of this, synthetic datasets can be considered and can include synthetic data that, while not real-world data, accurately represents characteristics of real-world data. As such, synthetic datasets can be used to, for example, train ML models that meet designated performance requirements (e.g., accuracy, precision, recall) when processing real-world data.

While synthetic data generation techniques exist for fully structured tabular data with well-defined data distributions, such techniques fall short when dealing with semi-structured data that combines structured fields with unstructured fields (e.g., free-text fields). The correlations and interdependencies between the structured data and the unstructured data give real-world datasets their distinctive characteristics and utility. Traditional approaches to synthetic data generation are unable to accurately recreate such correlations and interdependencies between the structured data and the unstructured data. For example, statistical sampling methods of traditional approaches are inadequate for synthesizing plausible semi-structured tabular data, while preserving these intricate relationships across data modalities. Maintaining privacy of any real-world data used to seed the generation process is also not guaranteed in traditional approaches.

In view of the above context, implementations of the present disclosure introduce a VAE that includes a set of LLMs to generate high-fidelity, synthetic, heterogeneous semi-structured tabular datasets from limited real-world data samples, while obfuscating the original data sources. As described in further detail herein, the VAE of the present disclosure can be described as a multi-modal tabular data VAE generative adversarial network (GAN) (MTV-GAN). In some implementations, synthetic datasets generated in accordance with implementations of the present disclosure can be used in various use cases including, for example, training of ML models.

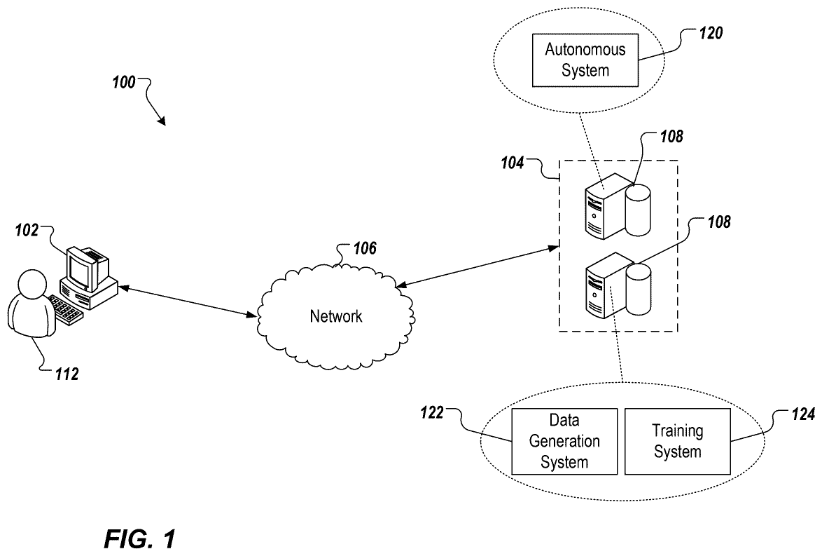

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106).

In some implementations, the server system 104 can host an autonomous system 120 that uses a ML model to match entities. That is, the server system 104 can receive computer-readable electronic documents (e.g., bank statements, invoice tables), and can match entities recorded in one document to one or more entities recorded in another document. Here, each document can record semi-structured data.

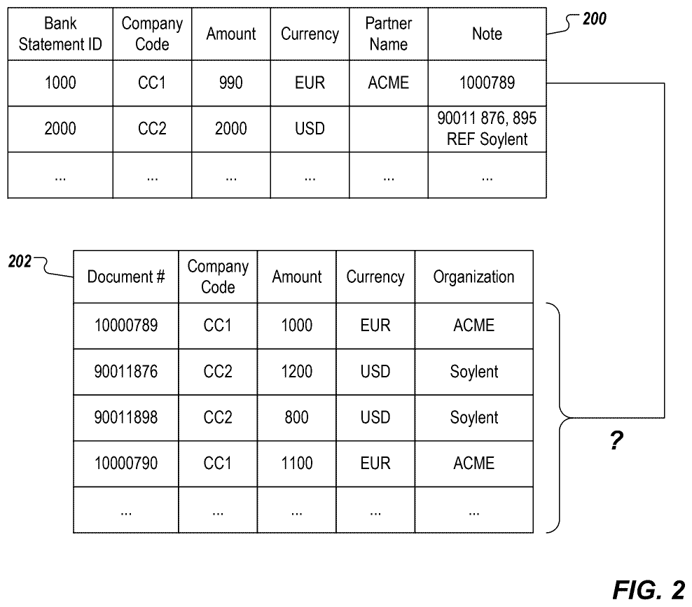

In the example context, FIG. 2 depicts portions of example electronic documents that record heterogenous, semi-structured data. In the example of FIG. 2, a first electronic document 200 includes a bank statement table that includes records representing payments received, and a second electronic document 202 includes an invoice table that includes records respectively representing invoices that had been issued. In the example context, each bank statement record is to be matched to one or more invoice records. Accordingly, the first electronic document 200 and the second electronic document 202 are processed using one or more ML models that provide predictions regarding matches between a bank statement record (entity) and one or more invoice records (entity/-ies).

Referring again to FIG. 1, the server system 104 can host a data generation system 122 for generating synthetic data provided as heterogenous, semi-structured data, as described in further detail herein. For example, the data generation system 122 of the present disclosure includes a MTV-GAN to generate high-fidelity, synthetic, heterogeneous semi-structured tabular datasets from limited real-world data samples, while obfuscating the original data sources. In some examples, the synthetic data is used by a training system 124 to train one or more ML models, such as the ML model of the autonomous system 120.

To provide further context for implementations of the present disclosure, a GAN includes a generator and a discriminator that are trained through adversarial training (e.g., unsupervised learning) to generate synthetic data based on real-world data, the synthetic data being accurately representative of real-world data. At a high-level, the generator generates synthetic data and the discriminator is tasked with distinguishing between the synthetic data and the real-world data. If the discriminator is able to discriminate between the synthetic data and the real-world data, at least a threshold percentage of times, the adversarial training continues. If the discriminator is unable to discriminate between the synthetic data and the real-world data, at or above the threshold percentage of times (e.g., 50% of the time), the adversarial training ceases, and the generator can be used to generate synthetic data that is to be used in real-world use cases.

Traditionally, each of the generator and the discriminator are provided as neural networks (e.g., multi-layer perceptrons, deep neural networks) that are untrained at the outset of the adversarial training process. Through the adversarial training process, hyperparameters of the neural networks are determined.

In contrast to traditional GANs, the MTV-GAN of the present disclosure leverages pre-trained LLMs for the generator and the discriminator. Example LLMs can include, but are not limited to, LLAMA, GEMMA, and Phi. The LLMs are provided by third-party enterprises, and as noted, are pre-trained on training data that is largely not representative of the domain that the synthetic data is to be generated for. As such, the LLMs can be described as general-purpose LLMs. For example, the third-party enterprises that train the LLMs likely do not have access to real-world data that the synthetic data is to be representative of. As one example, and with reference to the example problem space, the third-party enterprises do not have access to bank statements and/or invoices, as such data is confidential, hence the LLMs are not trained on such data.

In accordance with implementations of the present disclosure, the LLMs used for the MTV-GAN are fine-tuned using real-world data through the adversarial training process, as described in further detail herein. In general, fine-tuning adjusts parameters of the LLMs to change the focus of the LLMs from general-purpose tasks to specialized tasks in view of the particular domain (i.e., the domain that the real-world data is representative of). Fine-tuning can be described as adjusting parameters based on processing of the real-world data using an optimization algorithm (e.g., gradient descent). Over multiple iterations (epochs) of fine-tuning, the hyperparameters continue to be adjusted until achieving a configuration that minimizes error for the specific task (e.g., generating synthetic data). The result of fine-tuning is adapting previously learned general knowledge that is encoded in the pre-trained LLMs to the patterns and nuances represented in the real-world data used for fine-tuning.

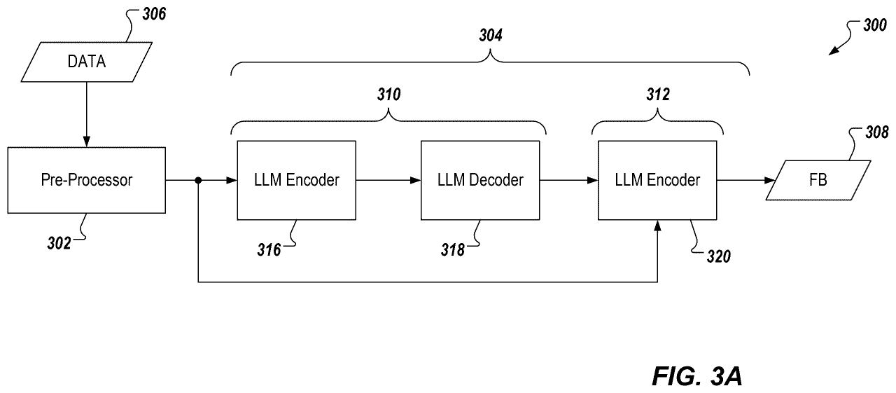

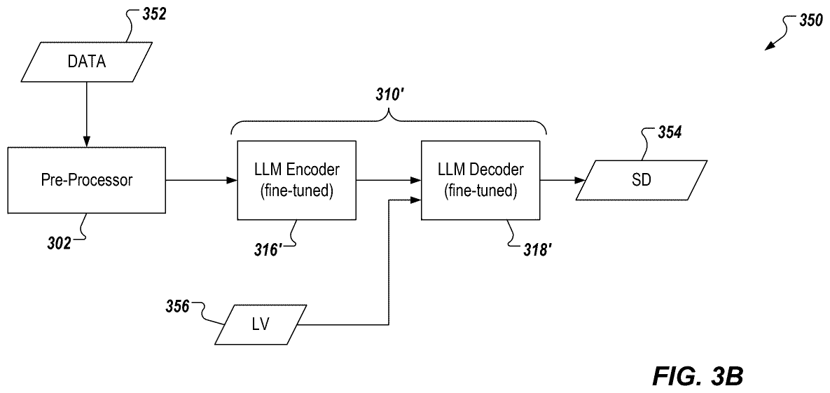

Implementations of the present disclosure are described in further detail herein with reference to example conceptual architectures. FIG. 3A depicts an example conceptual architecture 300 and FIG. 3B depicts an example conceptual architecture 350. In general, the conceptual architecture 300 of FIG. 3A represents fine-tuning of LLMs of the MTV-GAN of the present disclosure, and the conceptual architecture 350 of FIG. 3B represents use of the fine-tuned MTV-GAN to generate multi-model, semi-structured datasets.

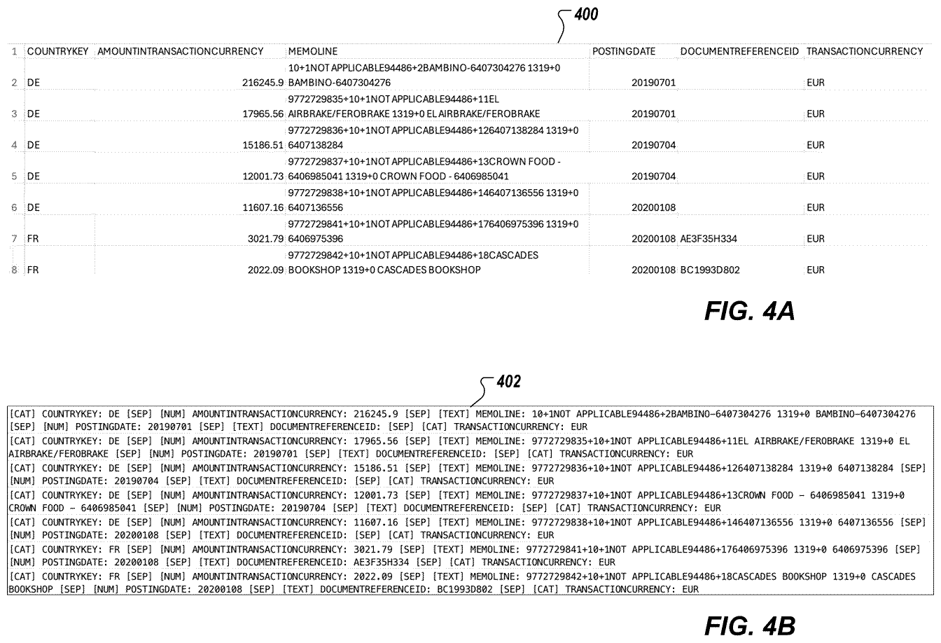

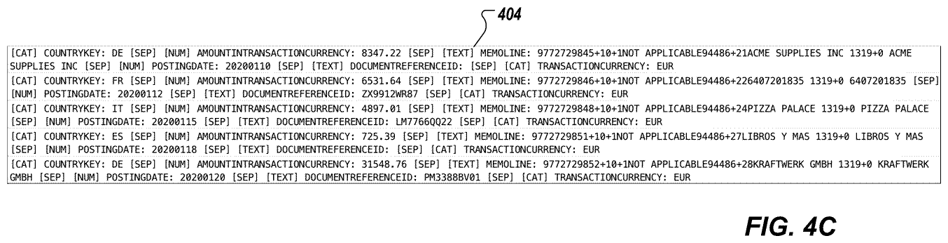

Implementations of the present disclosure are also described in further detail herein with reference to example data, example text strings, and example synthetic text strings. FIG. 4A depicts a portion of an example data table 400 that records real-world, semi-structured data. From the schema of the of the data table 400, structured data fields include the invoice fields COUNTRYKEY (a categorical with a set of COUNTRY codes), AMOUNTTRANSACTIONCURRENCY (a decimal number representing the invoice amount), TRANSACTIONCURRENCY (a categorical from a set of CURRENCY codes) and POSTINGDATE (a number representing the date). MEMOLINE and DOCUMENTREFERENCEID are text inputs that represent unstructured data. FIG. 4B depicts example text strings 402 generated based on records of the example data table 400 of FIG. 4A. FIG. 4C depicts example synthetic text strings 404 generated in accordance with implementations of the present disclosure.

In the example of FIG. 3A, the example conceptual architecture 300 includes a pre-processor 302 and a MTV-GAN 304. As described in further detail herein, during a fine-tuning process, data 306 is processed to fine-tune LLMs of the MTV-GAN 304, the fine-tuning resulting in feedback 308 for iterative fine-tuning. In some examples, the feedback 308 can represent a disparity between the data 306 and synthetic data generated by the MTV-GAN 304. In the example of FIG. 3A, the MTV-GAN 304 includes a generator 310 and a discriminator 312. The generator 310 includes an encoder 316 and a decoder 318. The encoder 316 leverages a LLM and the decoder 318 leverages a LLM, as described in further detail herein. The discriminator 312 includes an encoder 320 that leverages a LLM.

In some implementations, for each component (encoder, decoder, and discriminator) the same LLM is used, however, different, respective instances of the LLM are used. This, however, does not necessitate that each has the exact same architecture. Since the components are trained jointly, the same LLM architecture is provided in each component to make the training more efficient in terms of technical resources consumed. While there are dedicated ML models for encoding data into vectors, for example, a pretrained decoder-only LLM are trained with much more data than encoder-only architectures and thus should perform better in the generation task than encoder-specific ML models that are trained on significantly smaller pools of data.

In some implementations, the data 306 is real-world data. For example, and in the example problem space, the data 306 is a table that stores records of a bank statement, each record representing a payment that is received. As another example, and continuing with the example problem space, the data 306 is a table that stores records of a bank statement and, for each record, one or more invoices that match the record. As such, the data 306 can, for example, include confidential data.

In further detail, the data 306 is provided as a fine-tuning dataset that can be represented as D=x₁, x₂, . . . , xₙ, where xᵢ represents the i-th row of heterogeneous tabular data. The data table 400 of FIG. 4A depicts an example of real-world data. Each row xᵢ includes M columns c₁, c₂, . . . , cₘ, where each column cⱼ represents the j-th column and records data values of a respective data type (e.g., numerical, categorical, textual).

In some implementations, the pre-processor 302 processes the data 306 to reorganize the data into a set of strings, each string representing a respective row of the data 306. For example, for each row xᵢ in D, a text string tᵢ is constructed by concatenating stored values. Accordingly, a set of text strings can be provided as t₁, t₂, . . . , tₙ, where each text string tᵢ can be provided in the following example format:
[TYPE1] c_{1_name}: x_{i,1} [SEP] [TYPE2] c_{2_name}: x_{i,2} [SEP] . . . [TYPEM] c_{m_name}: x_{i,m}
   where [TYPEj] represents the data type of column cⱼ (e.g., “NUM” (numerical), “CAT” (categorical), or “TEXT” (free-text)), cⱼ_{ₙ}ₐₘₑ is the name of the j-th column, x_{i,j} represents the value of column cⱼ in row xᵢ, and [SEP] is a separator token used to delimit column values. In some examples, any missing value is represented by an empty string (e.g., [NUM] age: for a missing numerical age value). The example text strings 402 of FIG. 4B are generated based on records of the example data table 400 of FIG. 4A.

As described herein, pre-processing converts the heterogeneous tabular data into a sequential text format that can be processed by the LLMs used by the MTV-GAN 304. The inclusion of column names, data types, and separator tokens provides additional structure to the input to the MTV-GAN 304, which can enable the LLMs to learn the data patterns more effectively. For generalization, the order of the columns can be shuffled. That is, the columns need not be in the same order as provided in the data 306. As a note, removing positional encoding would not have the same effect, as the MTV-GAN 304 still needs to be aware of token positions inside the type, column name, and value triples.

In some examples, the fine-tuning process of the present disclosure uses multiple, disparate inputs generated for the data. A first input includes using the complete row without masking any tokens in the text string. A second input includes randomly masking tokens in the text string (e.g., each token in the text string having a 30% chance of being masked). A third input includes randomly masking columns (e.g., each column having a 10% chance of being masked), such that for each text string, tokens of selected columns are mased (e.g., “[TYPE] [col_name]: [value] [SEP]” is removed for each masked column).

At the outset of the fine-tuning process, the encoder 316 and the decoder 318 (the generator 310), and the encoder 320 (the discriminator 312) are initialized. For purposes of discussion Enc, Dec, and Dis are used to represent the pre-trained LLMs (e.g., LLAMA, GEMMA, Phi) of the encoder 316, the decoder 318, and the encoder 320, respectively, with weights initialized from their respective pre-trained checkpoints. In some examples, initialization means taking the LLMs as-is in their pre-trained state. In other words, taking the LLMs with their parameters values learned through training by the third-party provider.

In further detail, Enc is provided as a sequence-to-vector LLM that is pre-trained on a next-token prediction objective using a large text corpora (e.g., publicly available text corpora). Enc receives the preprocessed text string tᵢ as input and produces a latent vector representation zᵢ (e.g., zᵢ=Enc(tᵢ)), which can also be referred to as an embedding. Accordingly, a set of latent vectors z₁, z₂, . . . , zₙ can be provided, each latent vector representing a row in x₁, x₂, . . . , xₙ. In some examples, tᵢ is input into Enc. In some examples, tᵢ can be input to Enc with a prompt that specifies the task that the LLM is to perform (e.g., generate a latent vector using tᵢ).

During fine-tuning, a latent vector zᵢ is sampled using a prior distribution (e.g., a normal distribution). More particularly, Enc produces a set of tuples {(mu₁, var₁), . . . , (muₙ, varₙ)}, which are used as parameters of normal distributions. The set of latent vectors is produced by randomly sampling from the set of normal distributions {N(mu₁, var₁²), . . . , N(muₙ, varₙ²)}={z₁, z₂, . . . , zₙ} with N being the normal distribution parameterized by mu (μ) and var² (σ²). The normal distribution is defined as

$$N ( x ; μ , {σ}^{2} ) = \frac{1}{σ \sqrt{2 π}} {e}^{- {( x - μ )}^{2} ∖ 2 {σ}^{2}} .$$

Note that this operation is in general not differentiable. As such, a mechanism referred to as a reparameterization trick is used to differentiate through the sampling step and compute gradients for this operation.

In some implementations, Enc is fine-tuned jointly with Dec and Dis on the target dataset D (the data 306) to reconstruct the input text string tᵢ from the sampled latent vector zᵢ. Sampling regularizes the generation process and eliminates direct information passing from the input to the generated output and enables complex interactions and dependencies between different columns to be accounted for in the fine-tuning.

In some examples, Dec is a vector-to-sequence LLM that takes the latent vector zᵢ and column name (also referred to as column ID) embeddings as input to provide a synthetic text string

$${t}_{i}^{′} ( e . g . , {t}_{i}^{′} = Dec ( {z}_{i} , {col}_{i} ds ) .$$

Here, the column ID embeddings are learnable vector representations of the column IDs, which help Dec to condition the generation on the column structure. During fine-tuning, Dec learns a separate embedding of the columns, meaning there is an embedding layer that receives a list of available columns and for each column Dec learns a vector representing the semantic information of this column. These vectors, for each column, are averaged and are elementwise added to the latent vectors after sampling. As such, the embedding dimension of the column vectors is the same as the latent dimension of the latent vectors. If not all columns are present in the current input, it will be reflected in the column embedding. The example synthetic text strings 404 of FIG. 4C can be generated based on the example text strings 402 of FIG. 4B. In some examples, the decoder model is initialized as the pre-trained weights and fine-tuned jointly with the Enc and Dis.

In some examples, Dis is a binary classification LLM that processes the reconstructed text string

$${t}_{i}^{′}$$

as input and determines whether

$${t}_{i}^{′}$$

is realistic compared to a distribution of the data 306 as represented in the text strings t; provided from the pre-processor 302. For example, Dis determines whether the synthetic text strings 404 of FIG. 4C are realistic relative to the text strings 402 of FIG. 4B. In some examples, Dis is initialized as the pre-trained weights and fine-tuned jointly with Enc and Dec.

In some examples, Dis is fine-tuned with both reconstructed and real data to output a prediction as to whether the input data has been reconstructed. For real data, Dis should output a first value (e.g., 0) and for reconstructed data Dis should output a second value (e.g., 1). Through fine-tuning, Dis learns what real data looks like, or rather, what the distribution of real data looks like. If real data is easily distinguishable from reconstructed data, Dis can quickly learn to tell the distribution from the real data and the reconstructed data apart. Its loss for this discrimination would be very low. This low discrimination loss is then multiplied by −1 and added to the loss of the encoder-decoder VAE model, which will learn (through fine-tuning) to maximize the loss of Dis. This means producing a reconstructed output distribution that matches the actual real data distribution, making it harder for Dis to distinguish between real and reconstructed inputs.

It can be noted that the use of pre-trained LLMs as the initialization points for the Enc, Dec, and Dis enables use of the knowledge and patterns learned from large text corpora that had been used to pre-train the LLMs. This provides a better starting point for fine-tuning on the target dataset (e.g., the data 306), which can lead to improved performance and enable faster convergence.

As discussed above, Enc, Dec, and Dis are jointly fine-tuned. That is, for each iteration of fine-tuning (adversarial training), parameters of each of Enc, Dec, and Dis are adjusted (e.g., using gradient descent). In some examples, the fine-tuning uses a combination of a VAE reconstruction loss (e.g., representing a similarity (or dissimilarity) between the reconstructed data and the original data) and a GAN adversarial loss (e.g., representing a distance between the GAN distribution of the reconstructed data and the distribution of the original data). The VAE reconstruction loss encourages accurate reconstruction of the input data from the latent vector representation, while the GAN adversarial loss encourages the generated data to be indistinguishable from real-world data. In some examples, an overall loss is used and is determined as a weighted combination of the VAE reconstruction loss and the GAN adversarial loss. Through the fine-tuning process, the overall loss is minimized. Depending on the specific weight values, the input (real-world data) can be less precise, if the resulting output (generated data) is still close to being representative of real-world data.

Implementations of the present disclosure increase runtime and memory efficiency to enable execution using realistic technical constraints. For example, fine-tuning (and inference, discussed below) can be executed using a single graphics processing unit (GPU). In some examples, fine-tuning is executed for 5 epochs on the preprocessed dataset with a learning rate of 10⁻⁶ and a batch size of 4. In some examples, fine-tuning can include LoRA fine-tuning, which only trains a relatively small number of parameters and not all parameters of the LLM(s). In some examples, 8-bit model parameter quantization and an 8-bit Adam optimizer are used to further enhance technical efficiencies.

In the example of FIG. 3B, the example conceptual architecture 350 includes the pre-processor 302 and a fine-tuned generator 310′. In this example, the fine-tuned generator 310′ includes a fine-tuned encoder 316′ and a fine-tuned decoder 318′. Here, the fine-tuned generator 310′, the fine-tuned encoder 316′, and the fine-tuned decoder 318′ correspond to the generator 310, the encoder 316, and the decoder 318 after fine-tuning, as represented in and discussed herein with respect to FIG. 3A. As represented in FIG. 3B, after fine-tuning, the discriminator 312 (Dis) can be discarded as it is not needed for inference (generating synthetic data). In some implementations, synthetic data is generated in one of a random sampling mode and a partial row mode. As described in further detail herein, in the partial row mode, portions of data 352 are used to generate synthetic data 354 and, in the random sampling mode, latent vectors are randomly sampled to generate the synthetic data 354.

As described in further detail herein, the random sampling mode obviates the encoder after training and the generated rows are more random and potentially more privacy preserving with regard to the training data, as compared to the partial row mode. On the other hand, the partial input mode provides for more realistic generations, as compared to the random sampling mode, and provides for better control of which data is to by synthesized (e.g., the structured data could be kept constant and only text fields are generated). Both modes are privacy preserving, in that sensitive data from either the data 306 or the data 352 is not represented or leaked into the synthetic data that is generated.

In some examples, in the random sampling mode, a latent vector 356, denoted as z′ᵢ, is randomly sampled from the prior distribution p(z), which is typically a multivariate Gaussian or uniform distribution. In some examples, the latent vector 356 is randomly sampled from N(0, 1), which is the normal distribution with mean 0 and variance 1. During fine-tuning, the incentive was to produce parameters for the normal distribution of the latent variables that are close to N(0, 1), by, for example, adding a Kullback-Leibler (KL) divergence to the loss of the VAE model. The KL divergence is a measure of distance between two distributions and is defined as D_{KL} (P∥Q)=Σ₋{x∈X} P(x) log(P(x)/Q(x)) with P(x) and Q(x) being two probability distributions. Because the point is to learn distributions close to N(0, 1), the KL divergence is determined between the currently produced distributions {N(mu₁, var₁²), . . . , N(muₙ, varₙ²)} and {N(0, 1), . . . , N(0, 1)}. These distances are averaged and added as a KL loss term to the VAE model loss. As such, sampling the latent vector from N(0, 1) during the random sampling mode produces reliable and working synthetic data. In some examples, the fine-tuned decoder 318′ is used to generate a synthetic text string

$${t}_{i}^{′} ( e . g . , {t}_{i}^{′} = D e c ( {z}_{i}^{′} ) ) .$$

In some examples, the synthetic text string t′ᵢ is parsed to obtain a synthetic tabular data row

$${x}_{i}^{′} .$$

For example, parsing can be performed based on the format used to provide the text string tᵢ during fine-tuning, as discussed herein. For example, the colon (:) and the special separator token [SEP] indicate where cells of the row can be separated as well as the values that are to be used to populate the cells. For example, an example synthetic text string

$${t}_{i}^{′}$$

can be provided as:
[NUM] BS_ID: 1000 [SEP] [TEXT] CO_Code: CC1 [SEP] . . . [TEXT] NOTE: 1000789
   The example synthetic text string t′ᵢ can be parsed to provide the following example table row:

| BS_ID | CO_Code | . . . | NOTE |
|---|---|---|---|
| 1000 | CC1 | . . . | 1000789 |

In some examples, this can be repeated to generate a set of synthetic text strings

$${t}^{′} ( e . g . , {t}_{1}^{′} , {t}_{2}^{′} , … , {t}_{q}^{′} ) .$$

Each of the synthetic text string t′ can be parsed and combined to provide a synthetic data table.

In some examples, in the partial row mode, portions of the data 352 are used. As described herein, the partial row mode enables controlled generation of synthetic data, where real-world values for some columns can be used and synthetic data for the remaining columns is generated. For example, for each row xᵢ, a partial row x_{i,partial} is used as input, which contains values for a subset of columns. That is, while x_{i,partial} includes all columns of the row xᵢ, values for some of the columns are absent (empty). In some examples, the columns having missing values can include columns that store confidential information. The pre-processor 302 process x_{i,partial} into a text string t_{i,partial} using the same format as discussed above with respect to fine-tuning (e.g., using separator tokens, missing values represented by empty strings). The fine-tuned encoder 316′ uses the fine-tuned LLM to provide a latent vector z_{i,partial} (e.g., z_{i,partial}=ENC (t_{i,partial})). The fine-tuned decoder 318′ uses the fine-tuned LLM to generate missing values

$${t}_{i , missing}^{′} ( e . g . , {t}_{i , missing}^{′} = DEC ( {z}_{i , partial} ) ) .$$

In some examples, DEC(z_{i,partial}) produces a complete

$${t}_{i}^{′} ,$$

which also contains columns that were present in the partial input. However, to produce the complete output, only the values from

$${t}_{i}^{′}$$

that were missing in the partial input are used to fill out the columns. In some examples, t_{i,partial} and

$${t}_{i , missing}^{′}$$

are combined to obtain a complete synthetic row text string

$${t}_{i}^{′} .$$

For example, an example partial text string t_{i,partial} can be provided as:
[NUM] BS_ID: 1000 [SEP] [TEXT] CO_Code: CC1 [SEP] . . . [TEXT] NOTE:
   And an example missing text string

$${t}_{i , missing}^{′}$$

of missing values can be provided as:
[NUM] BS_ID: [SEP] [TEXT] CO_Code: [SEP] . . . [TEXT] NOTE: 1000789
   These examples can be combined to provide the example synthetic (semi-synthetic) text string

$${t}_{i}^{′}$$

as.
[NUM] BS_ID: 1000 [SEP] [TEXT] CO_Code: CC1 [SEP] . . . [TEXT] NOTE: 1000789
   The example synthetic text string

$${t}_{i}^{′}$$

can be parsed to provide the following example table row:

| BS_ID | CO_Code | . . . | NOTE |
|---|---|---|---|
| 1000 | CC1 | . . . | 1000789 |

In some examples, this can be repeated to generate a set of synthetic text strings

$${t}^{′} ( e . g . , {t}_{1}^{′} , {t}_{2}^{′} , … , {t}_{q}^{′} ) .$$

Each of the synthetic text string t′ can be parsed and combined to provide a synthetic data table.

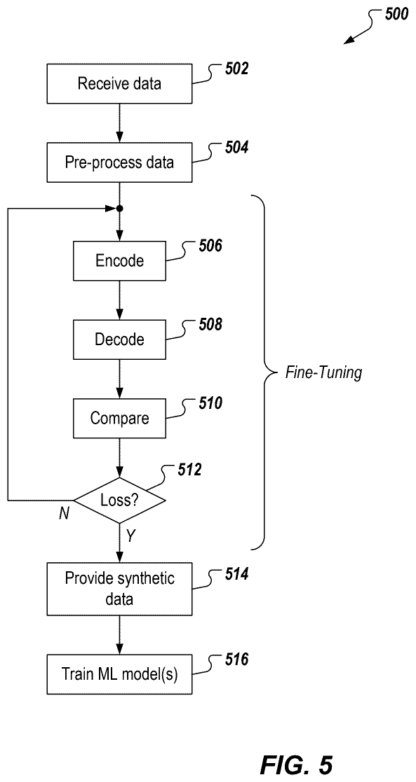

FIG. 5 depicts an example process 500 that can be executed in accordance with implementations of the present disclosure. In some examples, the example process 500 is provided using one or more computer-executable programs executed by one or more computing devices.

Data is received (502) and is pre-processed (504). For example, and as described herein with reference to FIG. 3A, the pre-processor 302 processes the data 306 to reorganize the data into a set of strings, each string representing a respective row of the data 306. Fine-tuning of the LLM(s) is executed. More particularly, for each epoch of an adversarial training process, text strings are encoded to provide latent vectors (506), the latent vectors are decoded into synthetic text strings (508), the synthetic text strings are compared to the text strings (510), and it is determined whether a loss meets a threshold loss (512). For example, and as described herein, the encoder 316 and the decoder 318 (the generator 310), and the encoder 320 (the discriminator 312) are initialized, and multiple iterations of an adversarial training process are executed to fine-tune parameters of the LLMs of the encoder 316 and the decoder 318 (the generator 310), and the encoder 320 (the discriminator 312). If the loss does not meet the threshold loss, another epoch of fine-tuning is executed. If the loss does meet the threshold loss, a synthetic dataset is provided (514). In some examples, instead of comparing the loss to the threshold loss, iterative fine-tuning is executed for a defined number of epochs (e.g., five epochs). As such, if the number of epochs have not yet been completed a synthetic dataset is provided (514). For example, and as described herein with reference to FIG. 3B, for each row xᵢ, a partial row x_{i,partial} is used as input, which contains values for a subset of columns. That is, while x_{i,partial} includes all columns of the row xᵢ, values for some of the columns are absent (empty). In some examples, the columns having missing values can include columns that store confidential information. The pre-processor 302 process x_{i,partial} into a text string t_{i,partial} using the same format as discussed above with respect to fine-tuning (e.g., using separator tokens, missing values represented by empty strings). The fine-tuned encoder 316′ uses the fine-tuned LLM to provide a latent vector z_{i,partial} (e.g., z_{i,partial}=ENC(t_{i,partial})). The fine-tuned decoder 318′ uses the fine-tuned LLM to generate missing values

$${t}_{i , missing}^{′} ( e . g . , {t}_{i , missing}^{′} = DEC ( {z}_{i , partial} ) ) .$$

This can be repeated to generate a set of synthetic text strings

$${t}^{′} ( e . g . , {t}_{1}^{′} , {t}_{2}^{′} , … , {t}_{q}^{′} ) .$$

Each of the synthetic text string t′ can be parsed and combined to provide a synthetic data table.

One or more ML models are trained using the synthetic dataset (516). For example, and as described herein, the synthetic data table can be used to train one or more ML models. An example ML model can include an entity matching model that matches entities represented in a computer-readable document to one or more entities represented in another computer-readable document. In some examples, the ML model is iteratively trained, where, during an iteration, also referred to as epoch, one or more parameters of the ML model are adjusted, and an output is generated based on the training data (e.g., class predictions). For each iteration, a loss value is determined based on a loss function. The loss value represents a degree of accuracy of the output of the ML model. The loss value can be described as a representation of a degree of difference between the output of the ML model and an expected output of the ML model (the expected output being provided from training data). In some examples, if the loss value does not meet an expected value (e.g., is not equal to zero), parameters of the ML model are adjusted in another iteration (epoch) of training. In some examples, the iterative training continues for a pre-defined number of iterations (epochs). In some examples, the iterative training continues until the loss value meets the expected value or is within a threshold range of the expected value.

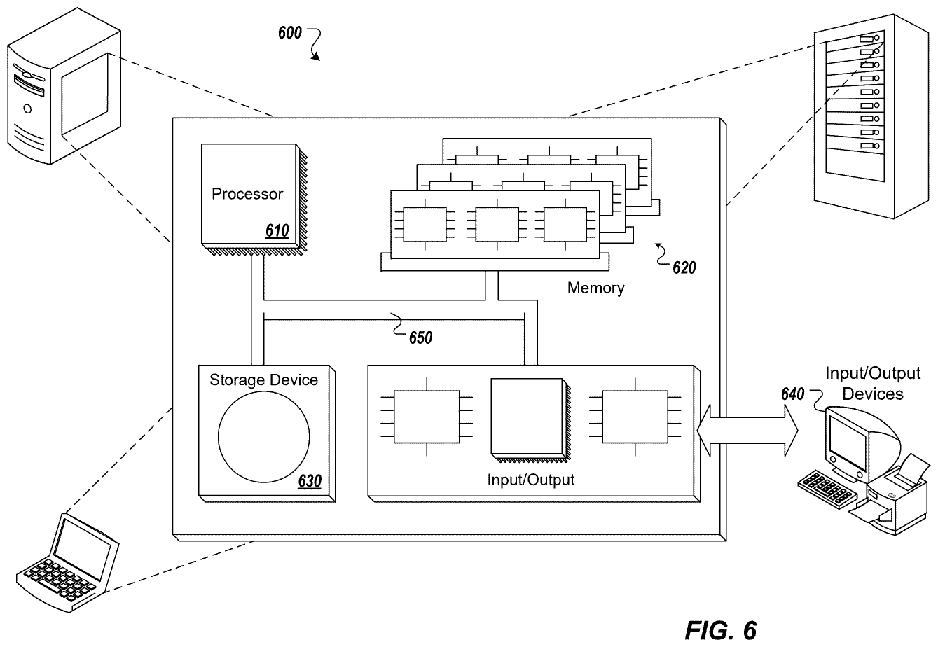

Referring now to FIG. 6, a schematic diagram of an example computing system 600 is provided. The system 600 can be used for the operations described in association with the implementations described herein. For example, the system 600 may be included in any or all of the server components discussed herein. The system 600 includes a processor 610, a memory 620, a storage device 630, and an input/output device 640. The components 610, 620, 630, 640 are interconnected using a system bus 650. The processor 610 is capable of processing instructions for execution within the system 600. In some implementations, the processor 610 is a single-threaded processor. In some implementations, the processor 610 is a multi-threaded processor. The processor 610 is capable of processing instructions stored in the memory 620 or on the storage device 630 to display graphical information for a user interface on the input/output device 640.

The memory 620 stores information within the system 600. In some implementations, the memory 620 is a computer-readable medium. In some implementations, the memory 620 is a volatile memory unit. In some implementations, the memory 620 is a non-volatile memory unit. The storage device 630 is capable of providing mass storage for the system 600. In some implementations, the storage device 630 is a computer-readable medium. In some implementations, the storage device 630 may be a floppy disk device, a hard disk device, an optical disk device, or a tape device. The input/output device 640 provides input/output operations for the system 600. In some implementations, the input/output device 640 includes a keyboard and/or pointing device. In some implementations, the input/output device 640 includes a display unit for displaying graphical user interfaces.

The features described can be implemented in digital electronic circuitry, or in computer hardware, firmware, software, or in combinations thereof. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for training a machine learning (ML) model using synthetic data, the method being executed by one or more processors and comprising:
during a fine-tuning phase:
receiving a first semi-structured data object comprising a set of columns and a set of rows, each row representing a record, at least one column recording unstructured data;
pre-processing rows of the first semi-structured data object to generate a first set of text strings, each text string representing a respective row of the first semi-structured data object, and
executing an adversarial training process using the first set of texts strings to fine-tune parameters of one or more large language models (LLMs) of a multi-modal tabular data variable autoencoder (VAE) generative adversarial network (GAN) (MTV-GAN) to provide a fine-tuned encoder and a fine-tuned decoder;
during a synthetic data generation phase:
processing a latent vector through the fine-tuned decoder of a VAE of the MTV-GAN to generate at least a portion of the synthetic data; and
during a training phase:
executing a training process to train the ML model using the synthetic data.

2. The method of claim 1, wherein the fine-tuned decoder decodes the latent vector to generate the at least a portion of the synthetic data.

3. The method of claim 1, wherein the fine-tuned encoder encodes a text string to provide the latent vector.

4. The method of claim 1, further comprising:
receiving a second semi-structured data object;
pre-processing rows of the second semi-structured data object to generate a second set of text strings, each text string representing a respective row of the second semi-structured data object; and
generating the latent vector using a text string of the second set of text string.

5. The method of claim 4, wherein the at least a portion of the synthetic data is generated by populating a partial text string with missing values that are generated by the fine-tuned decoder.

6. The method of claim 1, wherein each of the LLMs is trained prior to execution of the adversarial training process.

7. The method of claim 1, wherein data recorded in the first semi-structured data object comprises multi-modal data.

8. A non-transitory computer-readable storage medium coupled to one or more processors and having instructions stored thereon which, when executed by the one or more processors, cause the one or more processors to perform operations for training a machine learning (ML) model using synthetic data, the operations comprising:
during a fine-tuning phase:
receiving a first semi-structured data object comprising a set of columns and a set of rows, each row representing a record, at least one column recording unstructured data;
pre-processing rows of the first semi-structured data object to generate a first set of text strings, each text string representing a respective row of the first semi-structured data object, and
executing an adversarial training process using the first set of texts strings to fine-tune parameters of one or more large language models (LLMs) of a multi-modal tabular data variable autoencoder (VAE) generative adversarial network (GAN) (MTV-GAN) to provide a fine-tuned encoder and a fine-tuned decoder;
during a synthetic data generation phase:
processing a latent vector through the fine-tuned decoder of a VAE of the MTV-GAN to generate at least a portion of the synthetic data; and
during a training phase:
executing a training process to train the ML model using the synthetic data.

9. The non-transitory computer-readable storage medium of claim 8, wherein the fine-tuned decoder decodes the latent vector to generate the at least a portion of the synthetic data.

10. The non-transitory computer-readable storage medium of claim 8, wherein the fine-tuned encoder encodes a text string to provide the latent vector.

11. The non-transitory computer-readable storage medium of claim 8, wherein operations further comprise:
receiving a second semi-structured data object;
pre-processing rows of the second semi-structured data object to generate a second set of text strings, each text string representing a respective row of the second semi-structured data object; and
generating the latent vector using a text string of the second set of text string.

12. The non-transitory computer-readable storage medium of claim 11, wherein the at least a portion of the synthetic data is generated by populating a partial text string with missing values that are generated by the fine-tuned decoder.

13. The non-transitory computer-readable storage medium of claim 8, wherein each of the LLMs is trained prior to execution of the adversarial training process.

14. The non-transitory computer-readable storage medium of claim 8, wherein data recorded in the first semi-structured data object comprises multi-modal data.

15. A system, comprising:
a computing device; and
a computer-readable storage device coupled to the computing device and having instructions stored thereon which, when executed by the computing device, cause the computing device to perform operations for natural language explanations for training a machine learning (ML) model using synthetic data, the operations comprising:
during a fine-tuning phase:
receiving a first semi-structured data object comprising a set of columns and a set of rows, each row representing a record, at least one column recording unstructured data;
pre-processing rows of the first semi-structured data object to generate a first set of text strings, each text string representing a respective row of the first semi-structured data object, and
executing an adversarial training process using the first set of texts strings to fine-tune parameters of one or more large language models (LLMs) of a multi-modal tabular data variable autoencoder (VAE) generative adversarial network (GAN) (MTV-GAN) to provide a fine-tuned encoder and a fine-tuned decoder;
during a synthetic data generation phase:
processing a latent vector through the fine-tuned decoder of a VAE of the MTV-GAN to generate at least a portion of the synthetic data; and
during a training phase:
executing a training process to train the ML model using the synthetic data.

16. The system of claim 15, wherein the fine-tuned decoder decodes the latent vector to generate the at least a portion of the synthetic data.

17. The system of claim 15, wherein the fine-tuned encoder encodes a text string to provide the latent vector.

18. The system of claim 15, wherein operations further comprise:
receiving a second semi-structured data object;
pre-processing rows of the second semi-structured data object to generate a second set of text strings, each text string representing a respective row of the second semi-structured data object; and
generating the latent vector using a text string of the second set of text string.

19. The system of claim 18, wherein the at least a portion of the synthetic data is generated by populating a partial text string with missing values that are generated by the fine-tuned decoder.

20. The system of claim 15, wherein each of the LLMs is trained prior to execution of the adversarial training process.
